(19) United States
(12) Patent Application Publication
(10) Pub. No.: US 2024/0068785 A1
(43) Pub. Date: Feb. 29, 2024

(54) VEHICLE PROTECTION MECHANISM

(71) Applicant: Jonathan WANG, Hayward, CA (US)

(72) Inventor: Jonathan WANG, Hayward, CA (US)

(21) Appl. No.: 17/899,716

(22) Filed: Aug. 31, 2022

(51) Int. Cl. F41H 5/013; B60R 21/02; B62D 25/04

(52) U.S. Cl. CPC F41H 5/013; B60R 21/026; B62D 25/04

(57) ABSTRACT

A bullet-resistant panel for covering a portion of the vehicle may be movable between two positions. For example, the panel may be stored within a door in a lower position and then moved to an upper position to cover a window. An exemplary embodiment may include a mounting point, such as a sliding rail, to which the panel can be mounted to. A rail or a pair of rails may be placed along the sides of the panel to allow the panel to slide between positions. One or more of the rails may include a spring or hydraulic mechanism to facilitate movement between positions. The panel may further include a handle for a user to grasp in order to manually move the panel between positions. A locking mechanism can securely hold the panel in position.

### FIELD

An exemplary embodiment relates to the field of vehicle reinforcements.

### BACKGROUND

Various bullet-resistant panels can be fixed to a vehicle. Windows are often targeted since they provide a line of sight into the vehicle and may be a weak point. Various protectors can be placed in a vehicle, but often require expensive parts to fit over or replace existing vehicle panels and windows and may be labor-intensive to install. For example, bullet resistant glass windows may provide protection from gunfire, but may be difficult and expensive to install in a vehicle and must be sized specific to the vehicle. Panels can be installed over the windows but must be removable in order to provide the driver with a line of sight through the windows when operating the vehicle.

### SUMMARY

According to at least one exemplary embodiment, a method, system and apparatus for a movable bullet resistant panel for a vehicle may be shown and described. An exemplary embodiment may include a bulletproof or bullet-resistant panel which can cover a portion of the vehicle. The panel may be movable between two positions. For example, the panel may be stored in one position and then moved to another position for use. An exemplary embodiment may include a mounting point, such as a sliding rail, to which the panel can be mounted to. A rail or a pair of rails may be placed along the sides of the panel to allow the panel to slide between positions. One or more of the rails may include a spring or hydraulic mechanism to facilitate movement between positions. The panel may further include a handle for a user to grasp in order to manually move the panel between positions. A locking mechanism can securely hold the panel in position.

In an exemplary embodiment, the panel may be mounted to a vehicle door. For example, the sliding rails may be placed on the door and may extend into the door card or lower door panel. Thus, an embodiment may allow the panel to be secured within the door card in a lower position and then can allow the panel to be lifted up to an upper position to cover the windows of the door. The sliding rail may extend from the sides of the window down through the door panel or door card. The locking mechanism may be placed at the top of the door or vehicle body, securing the panel in the upper position. In an exemplary embodiment, the locking mechanism may grasp the panel using a magnet, buckle, hook, retainer clip, or any other contemplated mechanism for temporarily fixing the panel.

### BRIEF DESCRIPTION OF THE FIGURES

Advantages of embodiments of the present invention will be apparent from the following detailed description of the exemplary embodiments thereof, which description should be considered in conjunction with the accompanying drawings in which like numerals indicate like elements, in which:

FIG. 1A is an exemplary embodiment of a panel in a lower position.

FIG. 1B is an exemplary embodiment of a panel in an upper position.

FIG. 2A is an exemplary embodiment of an interior of a door with a panel in a lower position.

FIG. 2B is an exemplary embodiment of an interior of a door with a panel in a lower position.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

An exemplary embodiment may provide a panel for protecting a vehicle. For example, the panel may be mounted to a sliding rail mechanism to allow the panel to be movable between positions. This allows an exemplary embodiment to be stored in a lower position, where it may be concealed within the door panel of a vehicle door, and then moved into an upper position where it may cover the vehicle window.

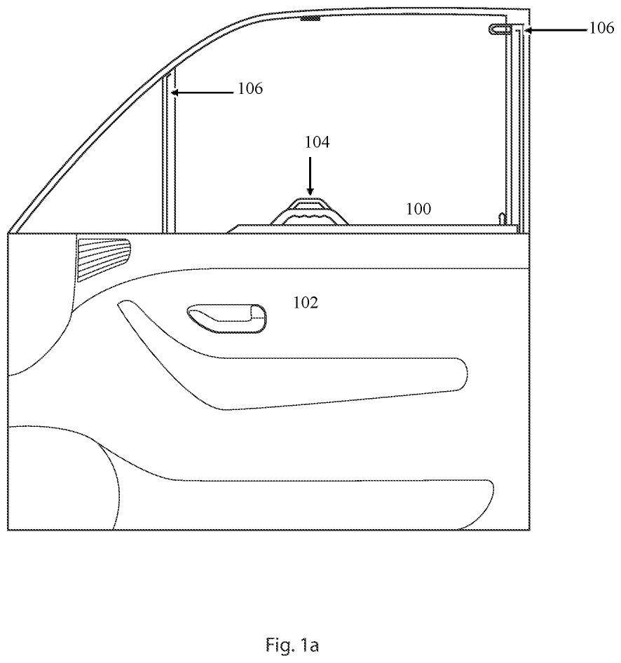

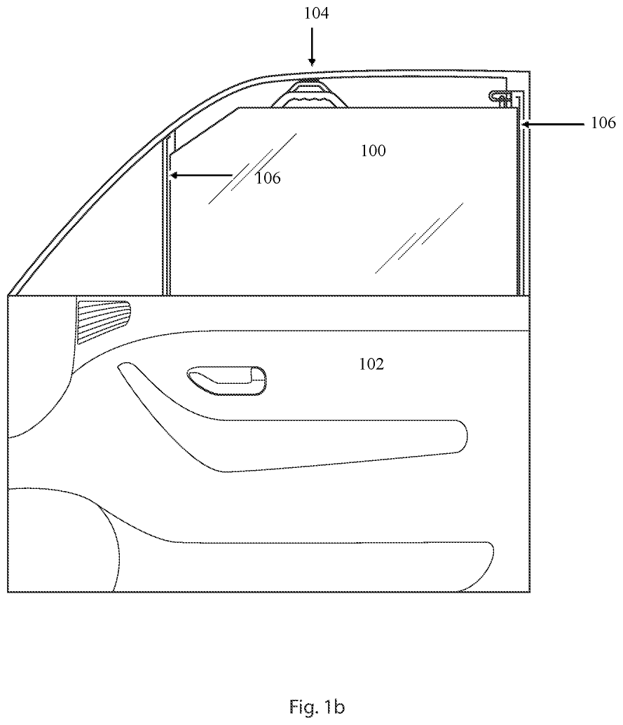

Referring now to FIG. 1A, FIG. 1A may illustrate an exemplary embodiment of a panel within a door card. The panel 100 may be concealed within a door card 102 of the vehicle. A handle 104 may be fixed to a portion of the panel 100 such that it is still revealed when the panel is concealed. An exemplary embodiment may include a sliding mechanism 106 along a side of the door. The sliding mechanism may be one or more rails along which the panel 100 is movable along. The sliding rails may be arranged on one or both sides of the panel 100 and may extend into the door card 102. The panel 100 may slide up the rail into an upper position, as shown in FIG. 1B.

A locking mechanism may be fixed to a top portion of the door, rail 106, or vehicle body in order to secure the panel 100 into the upper position. For example, the locking mechanism may be fixed onto the top of the door or vehicle body and may receive or latch onto the handle 104, which may be fixed to the panel 100. An additional locking mechanism may be placed at the bottom portion of the window or on the door of the vehicle to secure the panel 100 in the lower position. Thus, the panel 100 may be secured to the vehicle in an exemplary upper position by sliding the panel 100 upwards using the handle 104 and engaging the handle 104 with the locking mechanism. The locking mechanism may implement one or more magnets to magnetically connect to the handle. In another exemplary embodiment, a buckle or clasp may latch or hook onto the handle.

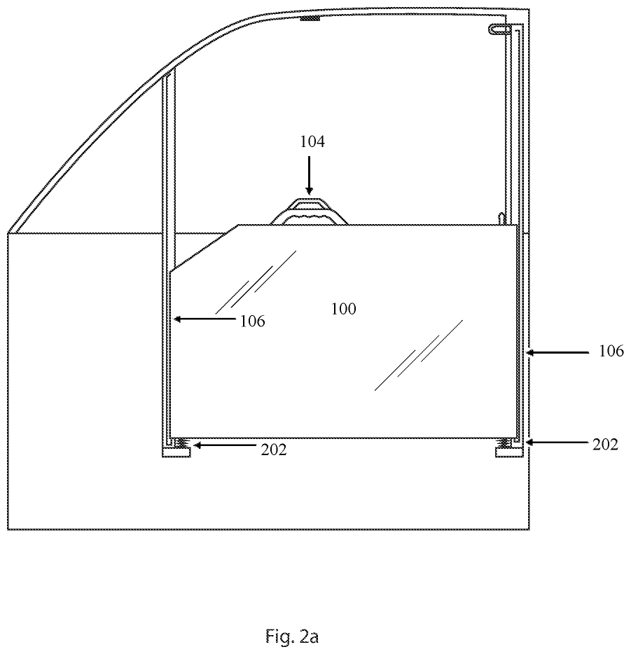

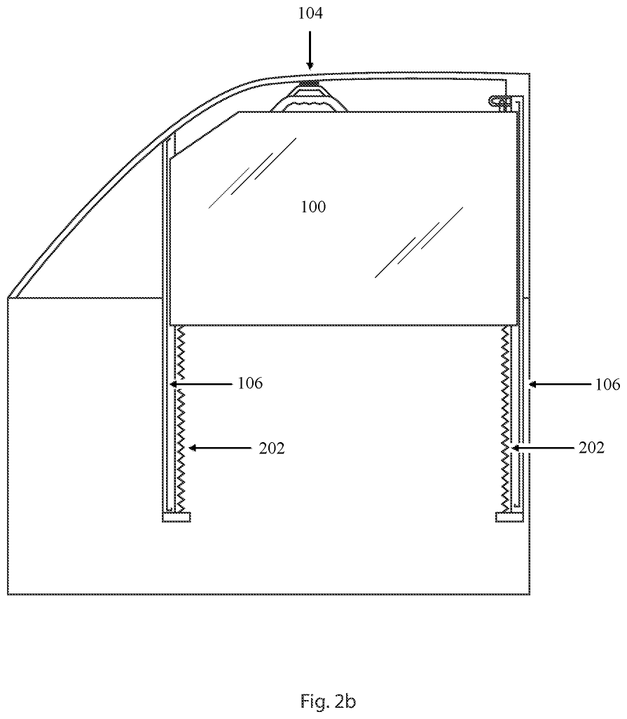

FIGS. 2A and 2B illustrate an interior view of a door in which the panel 100 is installed with the door card removed in order to illustrate the internal configuration of an exemplary embodiment. As shown in FIGS. 2A and 2B, the sliding mechanism 106 may extend into the door panel beneath the door card 102 to allow the panel 100 to be concealed within the door panel in the lower position. A spring mechanism 202 may be attached to the sliding mechanism 106 to facilitate in the movement of the panel 100. The spring mechanism 202 may include one or more tensioned springs within the rails or sliding mechanism 106. The tensioned springs may provide a force acting onto the sliding mechanism 106 or directly onto the panel 100. The force applied by the springs can reduce the amount of force required to activate or lift the panel 100 into, for example, an upper position. The tensioned springs can also ensure that a panel 100 in a lower position is stable by restricting vertical movement.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art (for example, features associated with certain configurations of the invention may instead be associated with any other configurations of the invention, as desired).

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A movable bullet-resistant apparatus for a vehicle, the bullet-resistant apparatus comprising:
a bullet-resistant panel movable between an upper position and a lower position;
a mounting point upon which the bullet-resistant panel is movable, wherein the mounting point permanently secures the bullet-resistant panel to the vehicle in a movable or slidable configuration such that the bullet-resistant panel can move between the upper position and the lower position;
a locking mechanism securely connected to the vehicle configured to securely lock the bullet-resistant panel in place in front of a window of the vehicle in the upper position; and
a handle securely connected to the bullet-resistant panel for moving the bullet-resistant panel.

2. The movable bullet-resistant apparatus of claim 1, wherein the locking mechanism comprises a first magnet configured to couple with a second magnet on the bullet-resistant panel when the bullet-resistant panel is in the upper position.

3. The movable bullet-resistant apparatus of claim 1, wherein the locking mechanism further comprises a buckle comprising a receiving member configured to receive a lug member that secures into a lateral opening on the receiving member upon sliding the bullet-resistant panel from the lower position to the upper position.

4. The movable bullet-resistant apparatus of claim 1, further comprising a spring-loaded mechanism comprising a spring configured to close into a loaded position when the bullet-resistant panel is in the lower position, wherein upon pressing a release button, the spring-loaded mechanism is configured to release the spring, applying a force onto the bullet-resistant panel into in a direction towards the upper position.

5. The movable bullet-resistant apparatus of claim 1, wherein the locking mechanism and/or mounting point is fixed to a B-Pillar of the vehicle.

6. The movable bullet-resistant apparatus of claim 1, wherein the mounting point comprises a pair of sliding rails on opposite sides of the bullet-resistant panel, wherein one of the sliding rails is secured to an A-Pillar of the vehicle and one of the sliding rails is secured to a B-Pillar of the vehicle.

7. The movable bullet-resistant apparatus of claim 1, wherein the mounting point comprises at least one sliding rail, wherein the sliding rail extends into a door of the vehicle, such that the bullet-resistant panel is on an inside of the door in the lower position.

8. The movable bullet-resistant apparatus of claim 7, wherein the bullet-resistant panel comprises a plurality of foldable or rollable sections, and wherein the bullet-resistant panel is configured to fold inside the door when in the lower position.

9. The movable bullet-resistant apparatus of claim 1, wherein the handle further comprises a plurality of finger grooves.
